(19) United States
(12) Patent Application Publication
(10) Pub. No.: US 2012/0108691 A1
(43) Pub. Date: May 3, 2012

(54) LOW DENSITY THERMOPLASTIC ELASTOMERS

(75) Inventor: Gerald W. Meyer, Crystal Lake, IL (US)

(73) Assignee: POLYONE CORPORATION, Avon Lake, OH (US)

(21) Appl. No.: 13/321,480

(22) PCT Filed: May 17, 2010
(86) PCT No.: PCT/US10/35104

§ 371 Date: Nov. 18, 2011

Related U.S. Application Data
(60) Provisional application No. 61/179,086, filed on May 18, 2009.

(51) Int. Cl. C08L 25/08; C08K 7/20; C08K 13/04; C08L 25/10

(52) U.S. Cl. 521/148; 521/146

(57) ABSTRACT

A thermoplastic elastomer (TPE) is disclosed which is foamed and has low density by virtue of the use of glass microspheres.

### CLAIM OF PRIORITY

This application claims priority from U.S. Provisional Patent Application Ser. No. 61/179,086 bearing Attorney Docket Number 12009009 and filed on May 18, 2009, which is incorporated by reference.

### FIELD OF THE INVENTION

This invention relates to low density thermoplastic elastomers, polymer compounds which exhibit elasticity while remaining thermoplastic, which also have very low density.

### BACKGROUND OF THE INVENTION

The world of polymers has progressed rapidly to transform material science from wood and metals of the 19^{th} Century to the use of thermoset polymers of the mid-20^{th} Century to the use of thermoplastic polymers of later 20^{th} Century.

Thermoplastic elastomers (TPEs) combine the benefits of elastomeric properties of thermoset polymers, such as vulcanized rubber, with the processing properties of thermoplastic polymers.

Traditionally, low density TPEs are prepared by foaming the TPE with a foaming agent after the TPE is manufactured. The foaming process basically involves melting the TPE via injection molding, extrusion, compression molding, rotational molding, etc., followed by mixing with a chemical blowing agent or high-pressure fluid. This second step produces bubbles or cells within the TPE causing the resulting in a foamed molten mass before cooling below its glass transition temperature into a foamed TPE compound.

The foamed TPE retains the properties of the TPE but weighs less because of reduced density, less mass per unit volume because of the entrapped blowing agent or gas.

The two main types of foaming techniques are (a) foaming by adding chemical blowing agent, “machine side” to the feed-throat of the barrel of the injection molding machine, extruder, etc., typically dry blended with the resin pellets, and (b) foaming by introducing fluid such as nitrogen gas or water into the melt stream of the TPE.

Foaming can add value to TPEs as a result of increased energy absorption, acoustic properties (if open celled) and potential cost savings. Foaming mainly helps with thick plastic articles—about 0.100 inch (2.54 mm) thick and above. The foaming helps reduce the part weight while maintaining the same volume.

The costs associated with using the two foaming methods can be prohibitive either from the increased cost of the foaming agent or the equipment needed to retrofit a typical molding machine to introduce foam into the TPE. Gas assisted foaming typically requires precise control over the velocity of the molten TPE in the injection machine barrel, precise temperature control and precise introduction of the foaming agent, all of which can add significant cost. Therefore, the effort to reduce cost by providing a lower density, same volume plastic article can be consumed by the capital expenditures for equipment and controls or by the additional cost of blowing agent additives or both.

### SUMMARY OF THE INVENTION

What the art needs is a new way to make foamed thermoplastic elastomer (also called “foamed TPE” or “low density TPE” herein). The art needs an economical way of making foamed TPE.

The present invention solves the problem by formulating a foamed TPE that utilizes glass microspheres to reduce density of a TPE within a given volume.

One aspect of the invention is a low density thermoplastic elastomer compound, comprising (a) styrene-containing thermoplastic elastomer and (b) an efficacious amount of glass microspheres to reduce density of the compound to less than 0.8 g/cm³; and optionally (c) plasticizer.

Another aspect of the invention is a low density plastic article made from the compound.

Features of the invention will become apparent with reference to the following embodiments.

### EMBODIMENTS OF THE INVENTION

### Styrene-Containing TPE

TPEs of the present invention are based on styrene (“TPE-S”) and are often compounded with plasticizer, antioxidant, thermal stabilizer, and one or more secondary polymers.

Non-limiting examples of TPE-S include styrene-ethylene-butylene-styrene, styrene-ethylene-propylene-styrene, styrene-ethylene-ethylene/propylene-styrene, styrene-isobutylene-styrene, styrene-butadiene-styrene, styrene-isoprene-styrene, and combinations thereof. These examples of TPE-S may or may not be maleated but have weight average molecular weights in excess of 75,000 and preferably in excess of 200,000. Of possible TPE-S candidates, styrene-ethylene-butylene-styrene (SEBS) is particularly useful because the olefinic mid-block is capable of holding large amounts of plasticizing oil.

Commercially available grades of these TPE-S compounds are made by Kraton Polymers (Houston, Tex., USA) and marketed using the Kraton brand. Of the preferred SEBS, those presently preferred grades are Kraton G1654H (a linear triblock copolymer based on styrene and ethylene/butylene with a polystyrene content between 29.5 and 32.5, a specific gravity of 0.92, and a Shore A hardness of 63) and Kraton G 1650M (a clear, linear triblock copolymer based on styrene and ethylene/butylene with a polystyrene content of 30%, a specific gravity of 0.91, and a Shore A hardness of 72).

Glass Microspheres

Glass microspheres are also known as glass microbeads. This product is well known for a variety of purposes, but has not been employed to reduce density of TPE in replacement of chemical blowing agents or fluids such as nitrogen gas or water vapor.

A useful summary of the status of glass microspheres can be found in United States Patent Application Publication No. US 2007/0012351 (Horemans) and assigned to 3M Company, a sophisticated user of glass microspheres for a variety of films, adhesives, reflective articles, etc. The remainder of this section is an adaptation from Horemans.

Glass microspheres can be any type of hollow or solid spheres. Generally however, hollow glass spheres are used. Useful microspheres are hollow, generally round but need not be perfectly spherical; they may be cratered or ellipsoidal, for example. Even though sometimes irregular in shape, they remain generally referred to as “microspheres”.

Glass microspheres can be generally from about 5 to 100 micrometers in volume average diameter. In a particular embodiment, the microspheres have a volume average diameter between 10 and 50 micrometers. A practical and typical volume average diameter can be from 15 to 40 micrometers. Microspheres comprising different sizes or a range of sizes can be used.

Glass microspheres should have a collapse strength in excess of the anticipated pressures that may arise during the mixing with the molten TPE in processing equipment. Generally, the microsphere should have a burst strength in excess of 4000 psi (27.6 MPa), preferably in excess of 5000 psi (34.5 MPa) as measured by ASTM D3102-78 with 10% collapse and percent of total volume instead of void volume as stated in the test. In a particular embodiment, the glass microspheres can have a burst strength of at least 15,000 psi or even higher such as for example at least 18,000 psi.

The density of hollow glass microspheres for use with this invention can vary from about 0.1 to 0.9 g/cm³, and is typically in the range of 0.2 to 0.7 g/cm³. Preferably, to reduce density of the TPE, the lower the density the better so long as the lower density maintains its collapse strength. Density is determined (according to ASTM D-2840-69) by weighing a sample of microspheres and determining the volume of the sample with an air comparison pycnometer (such as a AccuPyc 1330 Pycnometer or a Beckman Model 930).

Glass microspheres have been known for many years, as is shown by European Patent 0 091,555, and U.S. Pat. Nos. 2,978,340, 3,030,215, 3,129,086, 3,230,064, and U.S. Pat. No. 2,978,340, all of which teach a process of manufacture involving simultaneous fusion of the glass-forming components and expansion of the fused mass. U.S. Pat. No. 3,365,315 (Beck), U.S. Pat. No. 4,279,632 (Howell), U.S. Pat. No. 4,391,646 (Howell) and U.S. Pat. No. 4,767,726 (Marshall) teach an alternate process involving heating a glass composition containing an inorganic gas forming agent, and heating the glass to a temperature sufficient to liberate the gas and at which the glass has viscosity of less than about 104 poise.

Size of hollow glass microspheres can be controlled by the amount of sulfur-oxygen compounds in the particles, the length of time that the particles are heated, and by other means known in the art. The microspheres may be prepared on apparatus well known in the microspheres forming art, e.g., apparatus similar to that described in U.S. Pat. No. 3,230,064 or 3,129,086.

One method of preparing glass microspheres is taught in U.S. Pat. No. 3,030,215, which describes the inclusion of a blowing agent in an unfused raw batch of glass-forming oxides. Subsequent heating of the mixture simultaneously fuses the oxides to form glass and triggers the blowing agent to cause expansion. U.S. Pat. No. 3,365,315 describes an improved method of forming glass microspheres in which pre-formed amorphous glass particles are subsequently reheated and converted into glass microspheres. U.S. Pat. No. 4,391,646 discloses that incorporating 1-30 weight percent of B₂O₃, or boron trioxide, in glasses used to form microspheres, as in U.S. Pat. No. 3,365,315, improves strength, fluid properties, and moisture stability. A small amount of sodium borate remains on the surface of these microspheres, causing no problem in most applications. Removal of the sodium borate by washing is possible, but at a significant added expense; even where washing is carried out, however, additional sodium borate leaches out over a period of time.

Hollow glass microspheres are preferably prepared as described in U.S. Pat. No. 4,767,726. These microspheres are made from a borosilicate glass and have a chemical composition consisting essentially of SiO₂, CaO, Na₂O, B₂O₃, and SO₃ blowing agent. A characterizing feature of hollow microspheres resides in the alkaline metal earth oxide:alkali metal oxide (RO:R₂O) ratio, which substantially exceeds 1:1 and lies above the ratio present in any previously utilized simple borosilicate glass compositions. As the RO:R₂O ratio increases above 1:1, simple borosilicate compositions become increasingly unstable, devitrifying during traditional working and cooling cycles, so that “glass” compositions are not possible unless stabilizing agents such as Al₂O₃ are included in the composition. Such unstable compositions have been found to be highly desirable for making glass microspheres, rapid cooling of the molten gases by water quenching, to form frit, preventing devitrification. During subsequent bubble forming, as taught in aforementioned U.S. Pat. Nos. 3,365,315 and 4,391,646, the microspheres cool so rapidly that devitrification is prevented, despite the fact that the RO:R₂O ratio increases even further because of loss of the relatively more volatile alkali metal oxide compound during forming.

Suitable glass microspheres that can be used in connection with the present invention include those commercially available such as Scotchlite™ S60HS from 3M Company of St. Paul, Minn., USA or Q-Cel 6014 glass microbeads from Potters Industries of Valley Forge, Pa., USA. Presently preferred is the latter product, which has a bulk density 0.08 g/cm³, an effective density of 0.14 g/cm³, a mean particle size of 85 μm, a particle size range of 5-200 μm, and a maximum working pressure of 250 psi (1.723 MPa).

Optional Additives

The compound of the present invention can include conventional plastics additives in an amount that is sufficient to obtain a desired processing or performance property for the compound. The amount should not be wasteful of the additive or detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; smoke suppresants; impact modifiers; initiators; lubricants; micas; pigments, colorants and dyes; plasticizers; processing aids; other polymers; release agents; silanes, titanates and zirconates; slip and anti-blocking agents; stabilizers; stearates; ultraviolet light absorbers; viscosity regulators; waxes; and combinations of them.

Any conventional plasticizer, preferably a paraffinic oil, is suitable for use the present invention. The amount of plasticizer oil, if present, significantly influences the hardness of the resulting foamed TPE of the invention, such that the Shore Hardness as measured using ASTM D2240 (10 seconds) can range from about 0 to about 80 Shore 00 Hardness, and preferably from about 10 to about 40 Shore 00 Hardness. 60 Shore 00 Hardness is about 5 Shore A Hardness, the more familiar scale. Any value below about 52 Shore 00 Hardness is off the Shore A Hardness scale.

If plasticizer oil is present, the ratio of plasticizer oil to TPE can range from about 2:1 to about 15:1, and preferably from about 5:1 to about 10:1.

Within these Shore 00 Hardness ranges, it is proper to consider the foamed TPE to be a “flowable foamed TPE gel.”

A preferred anti-oxidant is an Irganox brand pentaerythritol antioxidant identified as CAS 6683-19-8. A preferred processing stabilizer is an Irgafos brand trisarylphosphite processing stabiliser identified as CAS No. 31570-04-4

Table 1 shows the acceptable, desirable, and preferable ranges of ingredients for the foamed TPE of the present invention.

TABLE 1
Ranges of Ingredients

| Ingredient | | | |
|---|---|---|---|
| (Wt. Percent) | Acceptable | Desirable | Preferable |
| TPE-S | 3-95% | 5-15% | 5-10% |
| Glass | 3-25% | 5-20% | 5-15% |
| Microspheres | | | |
| Plasticizer | 0-97% | 50-90% | 75-90% |
| Anti-oxidant | 0-3% | 0-2% | 0-1% |
| Processing | 0-3% | 0-2% | 0-1% |
| Stabilizer | | | |
| Other Optional | 0-15% | 0-10% | 0-5% |
| Additives | | | |

Processing

The preparation of compounds of the present invention is uncomplicated once the proper ingredients have been selected. The compound of the present can be made in batch or continuous operations.

Mixing in a continuous process typically occurs in an extruder that is elevated to a temperature that is sufficient to melt the polymer matrix with addition of all additives at the feed-throat, or by injection or side-feeders downstream. The glass microspheres are added typically by side-feeders alone or mixed with other additives. Extruder speeds can range from about 50 to about 500 revolutions per minute (rpm), and preferably from about 200 to about 400 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit homogenization of the compound components. The mixing speeds range from 60 to 2000 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

### USEFULNESS OF THE INVENTION

Foamed TPE of the present invention has an excellent versatility as a low density foamed TPE plastic article because of the presence of the glass microspheres, a solid physical addition to reduce density of the TPE without reliance on chemical blowing agents or high pressure fluids which require special and expensive additional equipment for manufacturing and processing.

The use of the optional plasticizer oil permits the foamed TPE to become a foamed TPE gel, of incredible softness.

The addition of anti-oxidant properties and thermal stabilization, by those respective functional additives makes the foamed TPE (and especially the foamed TPE gel) to have durable properties any plastic article should have.

The foamed TPE can be used in the molding or extruding or other shaping of plastic articles which benefits from the low density, low hardness, high durability, and elastomer properties of a fully thermoplastic material.

Markets or industries into which the foamed TPE can be introduced include appliances (refrigerators, freezers, washers, dryers, toasters, blenders, vacuum cleaners, coffee makers, and mixers); building and construction industries (pipes and fittings, trim, and molding); consumer goods (power hand tools, rakes, shovels, lawn mowers, shoes, boots, golf clubs, fishing poles, and watercraft); electrical/electronic products (printers, computers, business equipment, LCD projectors, mobile phones, connectors, chip trays, circuit breakers, and plugs); healthcare (wheelchairs, beds, testing equipment, analyzers, labware, ostomy goods, intra-venous sets, wound care, drug delivery, inhalers, and packaging); personal care products (toothbrushes, razors, combs, and hair brushes); industrial goods (containers, bottles, drums, material handling, gears, bearings, gaskets and seals, valves, and various safety equipment); packaging (food and beverage, cosmetic, detergents and cleaners, personal care, pharmaceutical and wellness); transportation (automotive aftermarket parts, window seals, and interior compartment parts); and wire and cable (cars and trucks, airplanes, aerospace, construction, military, telecommunication, utility power, alternative energy, and electronics). Of these various possibilities, foamed TPEs are particularly suitable for shoe insoles, pads, sound damping or shock absorbing parts, and insulators of all types.

### Examples

Table 2 shows six Examples of the present invention and two Comparative Examples, their formulations, sources of ingredients, processing conditions, and resulting properties.

TABLE 2

| Ingredient Name | A | 1 | 2 | B | 3 | 4 | 5 | 6 |
|---|---|---|---|---|---|---|---|---|
| | Formulation (Wt. %) | | | | | | | |
| Kraton G1654H SEBS (Kraton, | 8.84 | 8.40 | 7.96 | 6.63 | 7.51 | 4.84 | 7.96 | 0.00 |
| Houston, TX) | | | | | | | | |
| Kraton G1650M SEBS (Kraton) | 2.21 | 2.10 | 1.99 | 1.66 | 1.88 | 1.19 | 1.99 | 26.98 |
| Puretol 10 100 viscosity USP oil | 88.35 | 83.93 | 79.52 | 66.25 | 75.08 | 88.33 | 79.51 | 67.45 |
| plasticizer (PetroCanada, Calgary, | | | | | | | | |
| Alberta, Canada) | | | | | | | | |
| Irgafos 168 trisarylphosphite | 0.35 | 0.33 | 0.32 | 0.26 | 0.30 | 0.35 | 0.32 | 0.34 |
| processing stabilizer (Ciba Specialty | | | | | | | | |
| Chemicals, White Plains, NY) | | | | | | | | |
| Irganox 1010 Anti-oxidant (Ciba | 0.25 | 0.24 | 0.23 | 0.19 | 0.21 | 0.26 | 0.22 | 0.24 |
| Specialty Chemicals) | | | | | | | | |
| Q-Cel 6014 glass microbead density | 0.00 | 5.01 | 10.00 | 25.01 | 15.02 | 5.02 | 10.00 | 4.99 |
| reducer (Potters Industries, Valley | | | | | | | | |
| Forge, PA) | | | | | | | | |
| Ratio of Plasticizer to Resin | 8.00 | 8.00 | 8.00 | 8.00 | 8.00 | 14.64 | 7.99 | 2.50 |
| | Processing Conditions | | | | | | | |
| Mixing Equipment | 3.78 L Heated Vessel | | | | | | Leistritz Twin | |
| | | | | | | | screw extruder | |
| | | | | | | | (40-48 L/D) | |
| Mixing Temp. | 177-182° C. | | | | | | Zone 1: 93° C. | |
| | | | | | | | Zone 2: 121° C. | |
| | | | | | | | Zone 3: 149° C. | |
| | | | | | | | Zone 4: 149° C. | |
| | | | | | | | Zone 5: 149° C. | |
| | | | | | | | Zone 6: 149° C. | |
| | | | | | | | Zone 7: 127° C. | |
| | | | | | | | Zone 8: 116° C. | |
| | | | | | | | Zone 9: 104° C. | |
| | | | | | | | Zone 10: 93° C. | |
| | | | | | | | Die: 93° C. | |
| Mixing Speed | Hand mixing | | | | | | 260 rpm | |
| Order of Addition of Ingredients | Master- | Masterbatch, then | | | | Each | Masterbatch, then | |
| Masterbatch = Prior Mixture of | batch | Glass Microspheres | | | | added at | Glass | |
| SEBS, Oil, Anti-Oxidant, and Stabilizer | | | | | | same | Microspheres at | |
| | | | | | | time | side feeder | |
| Form of Product After Mixing | Clear | Foam | Foam | Slush | Foam | Foam | Foam | Foam |
| Foam = White, Low Density | Gel | | | | | | | |
| Foamed TPE Gel | | | | | | | | |
| Slush = No integrity to resulting mix | | | | | | | | |
| | Resulting Properties | | | | | | | |
| Shore 00 Hardness (ASTM D2240, 10 sec) | 3 | 21 | 32 | N/A | 42 | 13 | 28 | 59 |
| Specific Gravity (ASTM D792, 23° C.) | 0.85 | 0.69 | 0.59 | 0.45 | 0.55 | 0.65 | N/A | N/A |
| Density (g/cm³) (measured in cylinder | 0.86 | 0.65 | 0.57 | N/A | 0.53 | N/A | 0.69 | 0.78 |
| with known volume of 2.25 cm³) | | | | | | | | |
| Brookfield Viscosity (300° F., #27 | 7,200 | 17,600 | 59,600 | N/A | 204,000 | 850 | 27,300 | N/A |
| Spindle) (cps) | | | | | | | | |
| Brookfield Viscosity (350° F., #27 | 390 | 920 | 3,700 | N/A | 7,000 | 240 | 1,300 | 4,100 |
| Spindle) (cps) | | | | | | | | |

All Examples and Comparative Examples used plasticizer oil, but that is not a requirement of the invention for a low density TPE.

The addition of the hollow glass microspheres had a dramatic affect on specific gravity with even a 5 wt. % addition (Example 1 vs. Comparative Example A) resulting in about a 20% reduction in specific gravity with an increase in Shore 00 Hardness from 3 to 21 because the weight percent of the added glass microspheres replaced plasticizer oil content on a weight basis. With increasing weight of glass microspheres came increasing Shore 00 Hardness. (Examples 2-4 and Comparative Example B). Comparative Example B demonstrated the outer limit of amount of glass microspheres added to a conventional formulation of Comparative Example A, a TPE gel, because the resulting product had no practical integrity.

Shore 00 Hardness increased relative to Comparative Example A not only due to oil being replaced by glass microspheres but also due to the relatively higher hardness of the glass microspheres compared to other components of the gel formulation of Comparative Example A. For Examples 1-4, the resulting gel materials, after being cast, appeared as being foamed (light, airy, low density) as if traditional foaming agents had been used.

For Example 4, the gel was prepared from raw materials as opposed to a masterbatch and the glass spheres replaced a portion of the SEBS content, but had the same percentage of glass spheres as Example 1. The Shore 00 hardness for Example 4 was significantly lower than for Example 1, but still higher than Comparative Example A, while still exhibiting a specific gravity similar to the Example 1 having the same percentage of glass microspheres.

In general, because the glass microspheres reduced the density of the gel formulations, a significant cost/volume advantage resulted from these foamed TPE gels. Using present conventional manufacturing cost estimations, it was determined that incorporation of about 5-10 weight percent of hollow microspheres to a conventional TPE gel formulation could achieve a 20-25% lower cost for a plastic article of the same unit volume but lower density.

Examples 5 and 6 demonstrated the effect of harsher mixing techniques on the properties of the foamed TPE gels. Example 5 simulated Example 2 but used a commercial melt-mixing extruder and was found to have a reduced density compared with Comparative Example A, but not to the same magnitude as seen in Example 2 (0.69 g/cm³ vs. 0.57 g/cm³). Example 6 was constructed to test the effect of even more shear due to the higher SEBS solid content in the formulation during melt mixing and resulted in a density of 0.78 g/cm³. Examples 5 and 6 showed that more intense twin screw melt-mix compounding did reduce the effectiveness of the hollow glass microspheres to some degree, but still density reduction occurred. To obtain further density reduction, higher crush strength hollow glass microspheres would be used in compounds requiring twin screw melt-mixing.

The invention is not limited to the above embodiments. The claims follow.

1. A low density thermoplastic elastomer compound, comprising:
(a) styrene-containing thermoplastic elastomer and
(b) an efficacious amount of glass microspheres to reduce density of the compound to less than 0.8 g/cm³; and
optionally (c) plasticizer.

2. The compound of claim 1, wherein the styrene-containing thermoplastic elastomer is selected from the group consisting of styrene-ethylene-butylene-styrene, styrene-ethylene-propylene-styrene, styrene-ethylene-ethylene/propylene-styrene, styrene-isobutylene-styrene, styrene-butadiene-styrene, styrene-isoprene-styrene, and combinations thereof.

3. The compound of claim 1, wherein the styrene-containing thermoplastic elastomer is styrene-ethylene-butylene-styrene.

4. The compound of claim 3, wherein the styrene-ethylene-butylene-styrene has a polystyrene content of between about 29 and 32, a specific gravity of about 0.9, and a Shore A hardness of between about 60 and 75.

5. The compound of claim 1, wherein the plasticizer is present and is an oil.

6. The compound of claim 5, wherein the plasticizer is a paraffinic oil.

7. The compound of claim 1, wherein the glass microspheres have a volume average diameter of between about 5 and about 100 micrometers, wherein the glass microspheres have a collapse strength in excess of anticipated pressures that may arise during mixing of the compound, and have a density of between about 0.1 and about 0.9 g/cm³.

8. The compound of claim 1, further comprising adhesion promoters; biocides; anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; additional processing aids; release agents; silanes, titanates and zirconates; slip and anti-blocking agents; stabilizers; stearates; ultraviolet light absorbers; viscosity regulators; waxes; and combinations of them.

9. The compound of claim 1, wherein the weight percents of the ingredients comprise:

| | |
|---|---|
| Styrene-containing thermoplastic elastomer | 3-95% |
| Glass Microspheres | 3-25% |
| Plasticizer | 0-97% |
| Anti-oxidant | 0-3% |
| Processing Stabilizer | 0-3% |
| Other Optional Additives | 0-15% |

10. The compound of claim 9, wherein the weight percents of the ingredients comprise:

| | |
|---|---|
| Styrene-containing thermoplastic elastomer | 5-15% |
| Glass Microspheres | 5-20% |
| Plasticizer | 50-90% |
| Anti-oxidant | 0-2% |
| Processing Stabilizer | 0-2% |
| Other Optional Additives | 0-10% |

11. A thermoplastic article, comprising the compound of claim 1.

12. The article of claim 11, wherein the compound includes plasticizer and has a Shore 00 Hardness of from about 10 to about 60.

13. The article of claim 11, wherein the article is molded.

14. The article of claim 11, wherein the article is extruded.
